(19) United States
(12) Patent Application Publication
(10) Pub. No.: US 2007/0280663 A1
(43) Pub. Date: Dec. 6, 2007

(54) IMAGE-CAPTURING DEVICE

(75) Inventor: Chin-Hsin Ho, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: ALTEK CORPORATION, Hsinchu (TW)

(21) Appl. No.: 11/461,999

(22) Filed: Aug. 2, 2006

(30) Foreign Application Priority Data
Jun. 2, 2006 (TW) 095119714

(51) Int. Cl. G03B 13/18

(52) U.S. Cl. 396/89

(57) ABSTRACT

An image-capturing device including a shutter button for capturing an image and a focus button for focusing an image is provided. The focus button is disposed in a range where a user may press the shutter button. Before pressing the shutter button to capture an image, the user triggers the focus button firstly to focus the image.

### CROSS-REFERENCE TO RELATED APPLICATIONS

This non-provisional application claims priority under 35 U.S.C. § 119(a) on Patent Application No(s). 095119714 filed in Taiwan, R.O.C. on Jun. 2, 2006, the entire contents of which are hereby incorporated by reference.

### BACKGROUND OF THE INVENTION

1. Field of Invention

The present invention relates to an image-capturing device, and more particularly to an image-capturing device having a focus button and a shutter button being separated into two independent buttons.

2. Related Art

With rapid development of science and technology, in the current market, image-capturing devices with image shooting function, such as mobile phones, PDAs and digital cameras, have been popularized day by day because they are economically priced, and thus become tools providing convenience for recording events and objects in daily life or work. In the current market, most of the digital cameras employ a two-stage switch as a button to focus and shoot an image. When the two-stage switch is pressed halfway to a first-stage switch, an image to be captured is focused. After focusing and catching the image fully and accurately, the two-stage switch is pressed fully to a second-stage switch, and the image which has been focused is captured by a digital camera.

A digital camera in conventional art integrates the focus function and the shutter function into a two-stage switch which may perform the two functions simultaneously. As such, the space for accommodating electronic devices on the digital camera is decreased; however, in order to meet the requirements of lightness and thinness on electronic apparatus, such as a digital camera, the travel from the first-stage switch to the second-stage switch cannot be too long, thereby causing an excessively high sensitivity. Thus, when pressing the two-stage switch, mis-operation may easily occur due to unsuitable force control, thereby triggering the second-stage switch.

When pressing the two-stage switch, users with different tactility apply different forces to the switch; therefore, frequently, due to insufficient pressing force, the function of focusing cannot be performed, or due to excessively great pressing force, before fully focusing an image, the second-stage switch has already been triggered and thus the shot image is blur and out of focus. It is not so easy for the users not often using digital cameras or being incapable of accurately controlling force and tactility to focus an image with the two-stage switch. Users can control the force of “pressing the shutter halfway” only by operating and practicing repeatedly, which is quite time consuming and inconvenient.

Additionally, the price of the two-stage switch being higher than that of the single stage switch causes that the cost of the digital camera employing the two-stage switch to focus and shoot an image is increased and manufacturers must bear the additional cost. As such, manufactures have to raise the price of their products to accord with the high cost.

### SUMMARY OF THE INVENTION

Since a user cannot focus and shoot an image accurately only if he/she applies different pressing forces onto a two-stage button of a conventional digital camera, the user cannot perform the function of focusing due to insufficient pressing force or press a second-stage switch by mistake without fully focusing an image, and thus the shot image is blur and out of focus. As for the conventional two-stage switch, it is difficult to control the pressing force and besides that, the conventional two-stage switch is inconvenient in use.

In view of the aforementioned problems, the present invention provides an image-capturing device to solve the restriction or defects that it is difficult for users to control the force of pressing a shutter halfway and fully focus an image to be shot in the prior art and thus causing the shot image being blur and out of focus.

The image-capturing device disclosed by the present invention comprises a focus button for focusing an image and a shutter button for capturing an image. The focus button is disposed in a range where a user may press the shutter button. As such, before pressing the shutter button to capture an image, the focus button is triggered firstly to focus the image.

The present invention has the following function. The conventional two-stage switch is separated into two independent buttons, namely, the focus button and the shutter button, so as to solve the problem that too small travel of the two-stage switch causes that it is often difficult for users to press the shutter halfway to focus an image. Furthermore, the shutter button being a single-stage switch reduces the manufacturing cost.

Additionally, the focus button and the shutter button disclosed by the present invention are respectively disposed in the image-capturing device. Such a structure is simpler than the two-stage switch and may perform the preset functions of the buttons more exactly. The focus button is a pyroelectric IR sensor, such that the image-capturing device may achieve the object of focusing easily and rapidly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is an exploded schematic view of the first embodiment of the present invention.

FIG. 2A is an assembled schematic view of the first embodiment of the present invention.

FIG. 2B is a schematic sectional view of the first embodiment of the present invention.

FIG. 3 is a schematic view of utilizing the first embodiment of the present invention.

FIG. 4 is an exploded schematic view of the second embodiment of the present invention.

FIG. 5A is an assembled schematic view of the second embodiment of the present invention.

FIG. 5B is a schematic sectional view of the second embodiment of the present invention.

FIG. 6 is a schematic view of utilizing the second embodiment of the present invention.

### DETAILED DESCRIPTION OF THE INVENTION

The image-capturing devices disclosed by the present invention include, but not limited to, mobile phones, digital cameras, PDAs and other electronic products having image-capturing function. In the following detailed description of the present invention, a digital camera is taken as a preferred embodiment of the present invention. The accompanied drawings are only for reference and illustration and not for limiting the present invention.

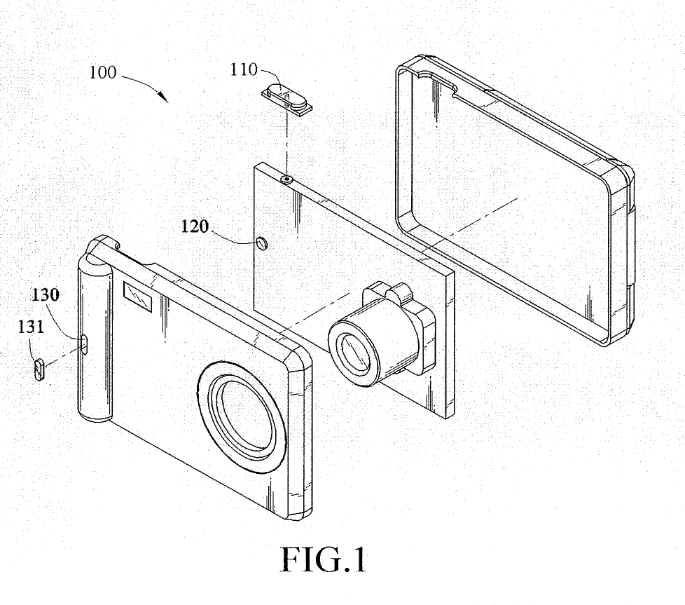

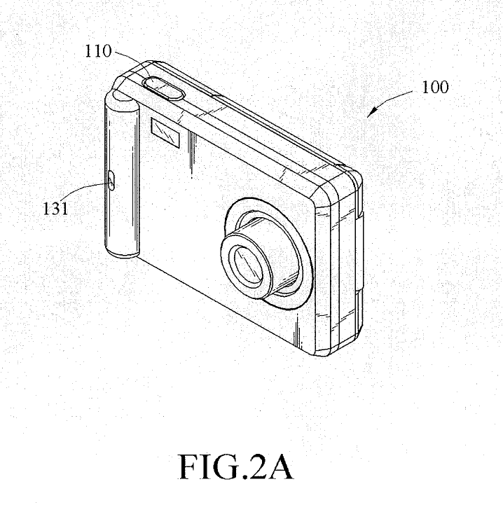

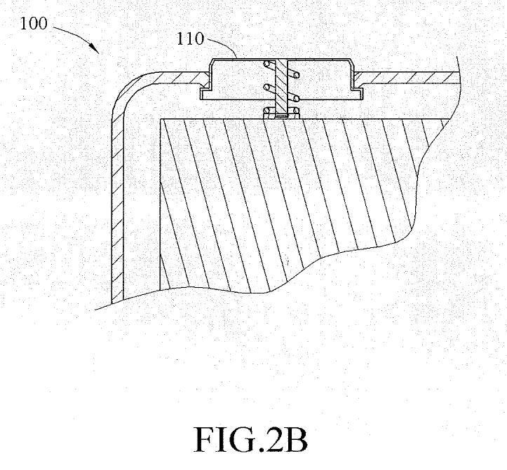

FIG. 1 and FIG. 2A are respectively an exploded schematic view and an assembled schematic view of the image-capturing device 100 according to the first embodiment of the present invention. As shown in the figures, the image-capturing device 100 comprises a shutter button 110 and a focus button 120. The shutter button 110 is disposed on one side of the upper case of the image-capturing device 100 to capture an image. The focus button 120 is disposed on a position where a circuit board of the image-capturing device 100 faces the front case, and in a range where a user may press the shutter button 110 without moving the hand, so as to perform the function of focusing an image.

Referring to FIG. 1 and FIG. 2A, the focus button 120 is a pyroelectric IR sensor which can sense the infrared rays from human bodies. Once the infrared sensor senses the infrared rays from human bodies, it generates a signal change to control the image-capturing device 100 to perform the image focusing function of the focus button 120. A through hole 130 corresponding to the focus button 120 is opened in the front case of the image-capturing device 100, so as to facilitate the user to press the position corresponding to the focus button 120. In order to protect the infrared sensor used as the focus button 120 from being contaminated with dust from the exterior, thereby influencing the sensitivity, and prevent liquid from flowing into the image-capturing device 100 through the through hole 130, thereby causing a short circuit of the internal electronic components, a transparent cover 131 is embedded into the through hole 130. The material of the transparent cover 131 is a transparent material that will not degrade the sensing efficiency of the focus button 120, such as acrylic or glass.

As shown in FIG. 2B, the shutter button 110 is a single-stage switch used as an interface to capture an image. The structure of the single-stage switch is simpler than the two-stage switch and thus may capture an image more exactly. Furthermore, the price of the single-stage switch is low, and thus the manufacturing cost is reduced if the single-stage switch is employed in the image-capturing device 100.

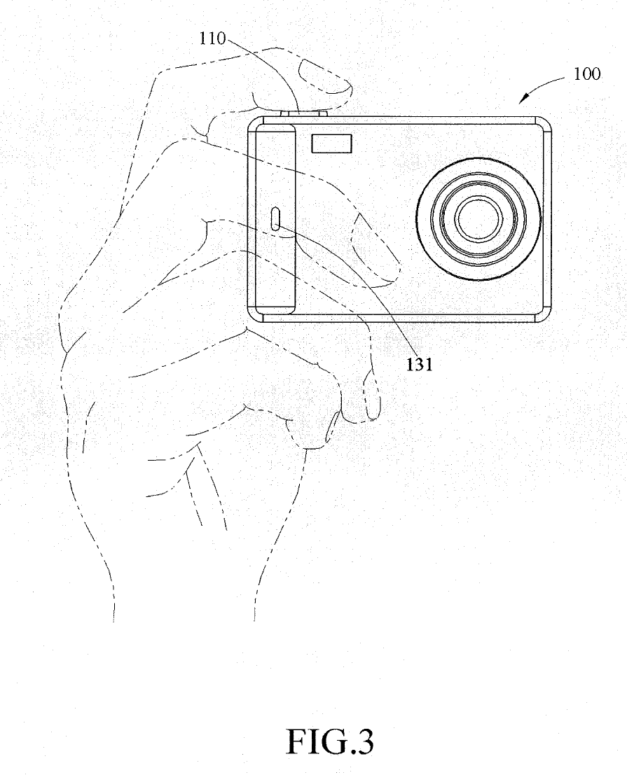

As shown in FIG. 2A and FIG. 3, when the user holds one side of the image-capturing device 110 and the finger just touches the through hole 130 corresponding to the focus button 120, the focus button 120 senses the change and then outputs a triggering signal, such that the image-capturing device 100 focuses an image automatically. The user observes the image to be captured through a display screen (not shown) and then presses the shutter button 110 to shoot the image clearly after the image is fully focused.

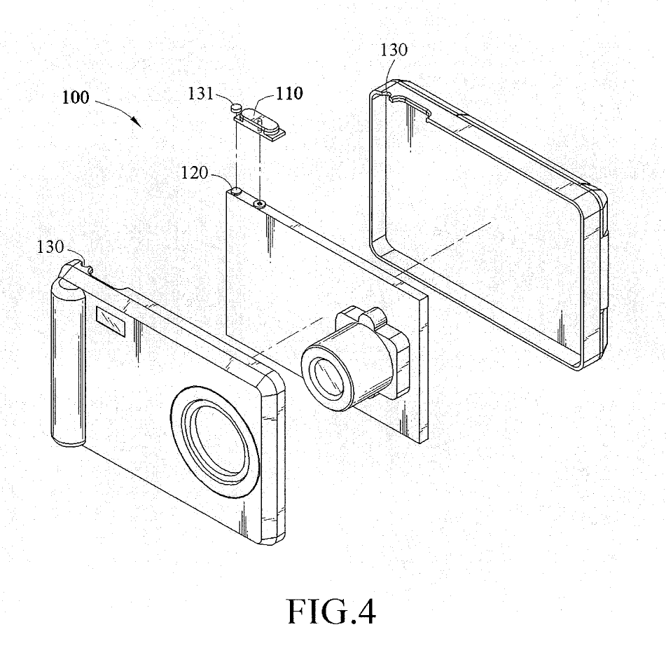

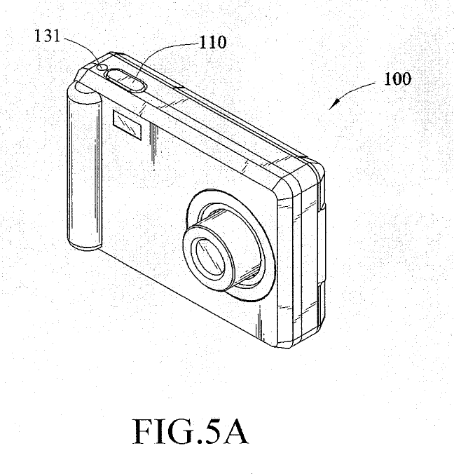

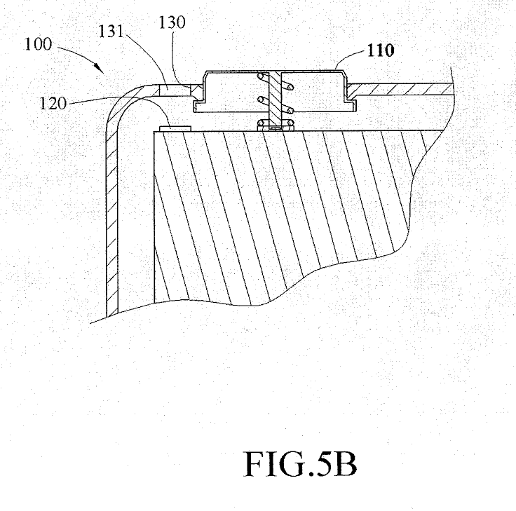

FIG. 4 and FIG. 5A are respectively an exploded schematic view and an assembled schematic view of the image-capturing device 100 according to the second embodiment of the present invention. As shown in the figures, the image-capturing device 100 comprises a shutter button 110 and a focus button 120. The shutter button 110 is disposed on one side of the upper case of the image-capturing device 100 to perform the image capturing function. The focus button 120 is disposed on the image-capturing device 100 opposite to the upper case and adjacent to the shutter button 100. Furthermore, the focus button 120 is also in a range where a user may press the shutter button 110 without moving the hand, so as to perform the image focusing function.

Referring to FIG. 5B, the focus button 120 is a pyroelectric IR sensor. A through hole 130 corresponding to the focus button 120 is opened in the case of the image-capturing device 100, and a transparent cover 131 is embedded into the through hole 130. The material of the transparent cover 131 is transparent material that will not degrade the sensing efficiency of the focus button 120, such as acrylic or glass. The shutter button 110 is a single-stage switch used as an interface to capture an image.

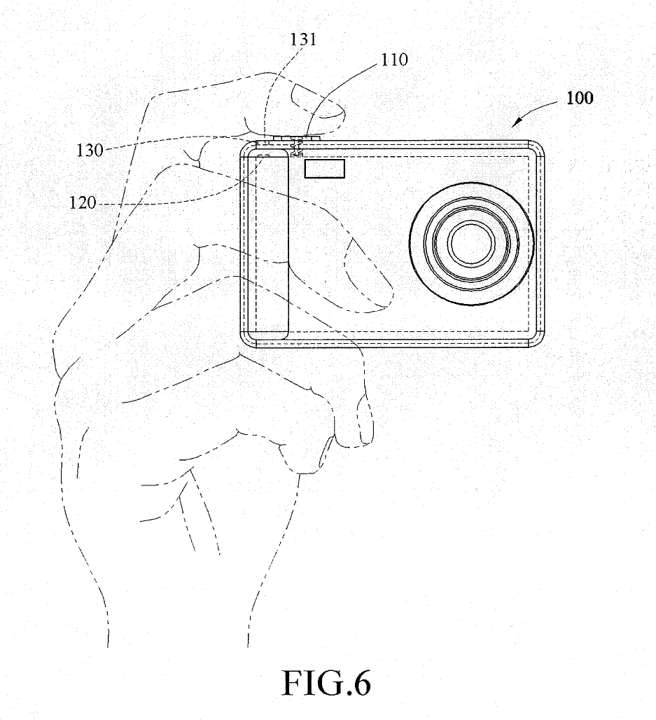

As shown in FIG. 5A and FIG. 6, when the user holds one side of the image-capturing device 100 and puts one of his/her fingers on the shutter button 110, the finger must cross over the through hole 130 corresponding to the focus button 120 firstly. When the focus button 120 senses the change, it outputs a triggering signal to make the image-capturing device 100 focuses an image automatically. The user observes the image to be captured through a display screen (not shown) and then presses the shutter button 110 to shoot the image clearly after the image is fully focused.

It should be noted that the focus button 120 disclosed by the present invention is disposed on the upper case and one side of the front case of the image-capturing device 100; however, it is not intended to limit the present invention, and those skilled in the art may change and design the focus button 120 to be in any position where the focus button 120 may be triggered to focus an image before the user presses the shutter button.

The present invention solves the problem that the object of focusing and shooting cannot be achieved only if the two-stage pressing operation mode is employed in the digital camera of the conventional art. Through the present invention, an image can be focused more conveniently, rapidly and exactly and the situation that an image which is shot by the user is often blurred is avoided.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image-capturing device, comprising:
a shutter button, disposed in the image-capturing device for capturing an image; and
a focus button, disposed in the image-capturing device and in a range where said shutter button is pressed conveniently for focusing an image.

2. The image-capturing device as claimed in claim 1, wherein said focus button and said shutter button are disposed on the same side of the image-capturing device.

3. The image-capturing device as claimed in claim 1, wherein said focus button and said shutter button are disposed on the adjacent two sides of the image-capturing device.

4. The image-capturing device as claimed in claim 1, wherein said focus button is a pyroelectric IR sensor.

5. The image-capturing device as claimed in claim 1, wherein a through hole corresponding to said focus button is further opened in the image-capturing device.

6. The image-capturing device as claimed in claim 5, wherein a transparent cover is embedded into the through hole.
